(19) United States
(12) Patent Application Publication
(10) Pub. No.: US 2025/0322594 A1
(43) Pub. Date: Oct. 16, 2025

(54) OPTIMIZED VIRTUAL REALITY SYSTEM

(71) Applicant: The Regents of the University of Colorado, a body corporate, Denver, CO (US)

(72) Inventors: Zhengxiong Li, Lone Tree, CO (US); Xingyu Chen, La Jolla, CA (US)

(21) Appl. No.: 19/178,366

(22) Filed: Apr. 14, 2025

Related U.S. Application Data
(60) Provisional application No. 63/634,370, filed on Apr. 15, 2024.

(51) Int. Cl. G06T 15/40; G06T 15/00; G06T 15/20

(52) U.S. Cl. CPC G06T 15/40; G06T 15/005; G06T 15/20

(57) ABSTRACT

A computer system for rendering three-dimensional video includes one or more processors and computer-readable media storing executable instructions. When executed by the processors, these instructions configure the system to receive virtual reality (VR) scene data for a first eye viewpoint and reproject at least a portion of this data to a second eye viewpoint. The system identifies individual pixels missing in the second eye viewpoint and patches these pixels by sampling colors from adjacent pixels. This approach facilitates efficient rendering of VR scenes by ensuring continuity and visual coherence between different eye viewpoints, enhancing the immersive experience in virtual reality environments.

### CROSS-REFERENCE TO RELATED APPLICATIONS

This application claims the benefit of and priority to U.S. Provisional Patent Application Ser. No. 63/634,370 filed on 15 Apr. 2024 and entitled “OPTIMIZED VIRTUAL REALITY SYSTEM,” which application is expressly incorporated herein by reference in its entirety.

### BACKGROUND

In the realm of three-dimensional video rendering, particularly for virtual reality (VR) applications, traditional methods have often relied on rendering separate images for each eye to create a stereoscopic effect. This approach typically involves generating two distinct frames from slightly different viewpoints corresponding to the left and right eyes. While this method can produce high-quality stereoscopic images, it is computationally intensive, requiring significant processing power and resources to render each frame independently. As a result, achieving real-time performance in VR applications can be challenging, especially on consumer-grade hardware.

To address the computational demands of rendering separate images for each eye, various techniques have been developed to optimize the rendering process. Despite these advancements, challenges remain in achieving a balance between computational efficiency and visual fidelity, as well as in handling dynamic scenes with high levels of detail.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system for rendering three-dimensional video, including: one or more processors; and one or more computer-readable media having stored thereon executable instructions that when executed by the one or more processors configure the computer system to perform at least the following: receive virtual reality (VR) scene data for a first eye viewpoint; reproject at least a portion of the VR scene data from the first eye viewpoint to a second eye viewpoint; identify a set of individual pixels that are missing in the second eye viewpoint; and patch the set of individual pixels by sampling pixel colors adjacent to the set of individual pixels.

In some aspects, the techniques described herein relate to a method for rendering three-dimensional video, including: receiving virtual reality (VR) scene data for a first eye viewpoint; reprojecting at least a portion of the VR scene data from the first eye viewpoint to a second eye viewpoint; identifying a set of individual pixels that are missing in the second eye viewpoint; and patching the set of individual pixels by sampling pixel colors adjacent to the set of individual pixels.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings described below.

FIG. 1 illustrates a system for implementing a You Only Render Once software application.

FIG. 2 illustrates a flowchart for a You Only Render Once software application.

FIG. 3 illustrates an excerpt of a programming algorithm for an embodiment of a Reprojector First Stage.

FIG. 4 illustrates an excerpt of a programming algorithm for an embodiment of a Reprojector Second Stage.

FIG. 5 illustrates an excerpt of a programming algorithm for an embodiment of a Patcher Stage.

FIG. 6 illustrates an embodiment of a kernel applied to a disocclusion.

FIG. 7 illustrates a flowchart for a steps within a three-dimensional rendering method.

### DETAILED DESCRIPTION

Mobile Virtual Reality (VR) can assist in achieving convenient and immersive human-computer interaction and realizing emerging applications. However, existing VR technologies typically require two separate renderings of binocular images, causing a significant bottleneck for mobile devices with limited computing capability and power supply. Disclosed embodiments disclose an approach to rendering optimization for mobile VR called You Only Render Once (“YORO”).

By utilizing the per-pixel attribute, YORO can generate binocular VR images from the monocular image through one rendering, saving half the computation of other conventional approaches. Disclosed embodiments teach a new optimization type for energy-saving and efficient mobile VR. Disclosed embodiments may provide one or more of the following benefits: (i) Energy-saving: it may require less energy to provide the equivalent user experience, which may prevent heat and processor degradation while improving battery life on mobile VR applications; (ii) Efficiency: it may make mobile VR more efficient and reliable on fewer computing resources in practice; and (iii) Practical: it may provide a general framework-level approach for VR applications that does not need specialized hardware and is compatible with most current mobile product platforms.

At least some embodiments comprise a new reprojection matrix to quickly reproject frames from one eye to the other, followed by a new filter-based patching method to fill in the missing information. The disclosed algorithm may comprise about half of the computational complexity compared to conventional rendering algorithms. This in turn improves the energy efficiency of the entire VR system.

Additionally, at least some embodiments implement the YORO as an efficient software framework underlying practical VR applications. To achieve the goal of computation efficiency and energy saving, disclosed embodiments may implement the YORO rendering algorithms in a lightweight and highly parallel way.

Within conventional systems, the rendering process in VR generates 2D images or frames as a field of view (FoV) originating from the 3D scene. The locations and shapes of the objects in an image/frame are determined by their geometry, the characteristics of the environment, and the placement of the camera in that environment. The appearance of the objects is affected by material properties, light sources, textures, and shading models. In conventional systems, geometry is described by a large collection of triangles grouped into 3D meshes together to approximate the contour of 3D objects in the scene. Therefore, the number of triangles can be a measure of scene complexity, with a higher number of triangles usually resulting in more detailed and realistic imagery. In mobile VR, rendering may rely on rasterization, a computationally efficient technique that transforms 3D scenes into 2D pixels.

The conventional rasterized rendering pipeline can comprise two steps: (1) Projection: The renderer utilizes view matrices that depend on the position and rotation of the camera to transform the input geometry from model coordinate space to view space. Then the geometry will be converted into clipping space using the projection matrix, which depends on the parameters of the camera. Here the redundant geometry is clipped out, and finally, the geometry is mapped to the screen space. (2) Shading: The geometry is then rasterized to the screen pixels and colored by the fragment shader. The color of a pixel depends on many factors, such as texture, reflection, refraction, direct and indirect light, and air medium. Therefore, the shading process is often more computationally expensive than the projection process.

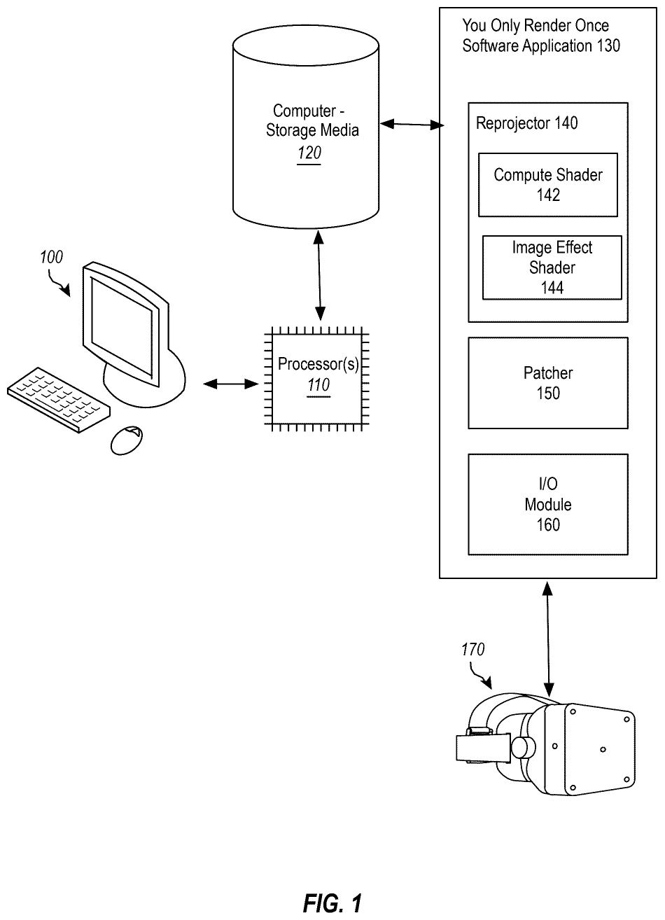

Turning now to the figures, FIG. 1 illustrates a computer system 100 for implementing a You Only Render Once software application. In FIG. 1, a computer system 100 comprises one or more processors 110 and one or more computer-storage media 120. The computer-storage media 120 comprises instructions that when executed cause a YORO software application 130 to execute. The YORO software application 130 may comprise a Reprojector 140, with an associated Computer Shader 142 and Image Effect Shader 144, a Patcher 150, and an I/O Module 160. The I/O Module 160 may communicate with a VR Device 170. For the sake of simplicity and example, the computer system 100 is depicted as a single, unitary computer. Nevertheless, in various alternative embodiments the computer system 100 may comprise multiple separate computer systems, including computer systems that are geographically remote to each other.

In at least one embodiment, virtual reality (VR) scene data is stored within the one or more computer-storage media 120. The VR scene data may be provided by a software application, such as a video game, or by any other digital source. The VR scene data may comprise RGB data and depth data. Within RGB data, the Red-Green-Blue three-channel image represents the color of the rendering. RGB is the color model used in mainstream electronic devices and picture formats, as it is based on the principle of monitor display and human perception of color. While, nearly all mainstream renderer solutions output RGB images, alternative color spaces can be used within the scope of at least one embodiment.

Typically, within depth data, the depth image is a grayscale image (single-channel) in which each pixel's brightness represents the distance of the object in logarithmic space. The brighter the pixel, the closer to the camera. In at least one embodiment, the VR scene data comprise parts of G-buffers, which is a screen space representation of geometry and material information of the rendering process. It is worth noting that getting the G-buffers does not add extra computation since it is already given by the regular rendering pipeline. After obtaining the VR scene data, the computer system 100 can usually simulate visual effects on images, such as post-processing effects (occlusion, reflection, shadow, mobile blur, etc.). Thus, disclosed embodiments are able to leverage this optimization by utilizing the G-buffers which have already been generated as part of the regular rendering pipeline, without extra computational costs.

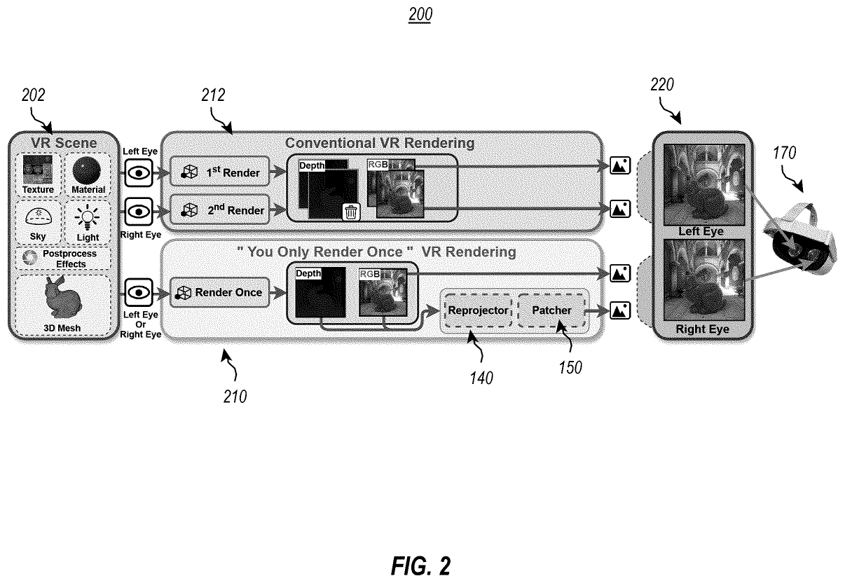

FIG. 2 illustrates a flowchart 200 for a You Only Render Once software application. The flowchart 200 includes box representing VR scene data 202, a box representing a YORO process 210, a box representing a conventional VR rendering process 212, and a final box representing a first eye viewpoint rendering and a second eye viewpoint rendering 220. The flowchart 200 also includes a VR device 170 that can be used to perform the YORO process 210 and/or used to view the first eye viewpoint rendering and second eye viewpoint rendering 220.

In at least one embodiment, in contrast to the conventional VR rendering process 212, which requires one render for each eye image, the YORO process 210 only renders once for a first eye viewpoint and second eye viewpoint. In at least one embodiment, the first eye viewpoint may comprise the dominant eye of the user. The dominant eye is decided by personal habits and may remain unchanged across VR applications.

The YORO process 210 may generate intermediate results that contain the RGB color image and the depth image. The intermediate results are then fed into the Reprojector 140. The Reprojector 140 can be configured to quickly create a new cropped geometry based on the RGB and depth pixel information within the VR scene data 202. This cropped geometry is then reprojected. The final output of the Reprojector may be one or more resolution-independent Intermediate Buffers (ImBuffer).

The ImBuffer may then be fed into the Patcher 150, which leverages information from the ImBuffer to sample and fill in the disocclusion (i.e., scene regions that become newly visible to the second eye viewpoint but were not visible in the original rendering for the first eye viewpoint). The rendered and patched frames are combined as the binocular image and then communicated through the I/O module 160 for display on the VR device 170.

In at least one embodiment, when reprojecting from one eye to the other, the Reprojector 140 will only displace pixels in the opposite direction. For example, when the Reprojector 140 reprojects from the right eye to the left eye, all pixels will only displace along the positive X-axis (i.e., to the right) for a certain distance (range from 0 to texture width). As such, disclosed embodiments can save computing time by completely disregarding the calculation of the Y-axis and the negative X-axis.

Additionally, in at least one embodiment, the depth of the disocclusion is always further than the nearest colored pixel in the opposite direction (when the right eye is the dominant eye). In other words, the disocclusion should always be patched with background pixel information, not foreground pixel information. This may optimize the rendering process by reducing unnecessary calculations and focusing only on the background when filling in the disocclusion.

Turning now to the Reprojector 140, this module assists in generating a second eye viewpoint from a first eye viewpoint with depth information to form a binocular image. In other words, the Reprojector 140 reconstructs a new frame with a different perspective through existing color and depth information-information that can be naturally obtained from the conventional rendering process used to generate the first eye viewpoint. Conventional mainstream real-time rendering is dominated by the rasterization renderer. Its general idea is to traverse each triangle of each 3D model in the scene and project it from the world space to the screen space using a view and a projection matrix.

At least one embodiment of matrices is denoted below:

$$R = [ \begin{matrix}1 - 2 {r}_{z}^{2} - 2 {r}_{w}^{2} & 2 {r}_{y} {r}_{z} - 2 {r}_{x} {r}_{w} & 2 {r}_{y} {r}_{w} + 2 {r}_{x} {r}_{z} & 0 \\ 2 {r}_{y} {r}_{z} + 2 {r}_{x} {r}_{w} & 1 - 2 {r}_{y}^{2} - 2 {r}_{w}^{2} & 2 {r}_{z} {r}_{w} - 2 {r}_{x} {r}_{y} & 0 \\ 2 {r}_{y} {r}_{w} - 2 {r}_{x} {r}_{z} & 2 {r}_{z} {r}_{w} + 2 {r}_{x} {r}_{y} & 1 - 2 {r}_{y}^{2} - 2 {r}_{z}^{2} & 0 \\ 0 & 0 & 0 & 1\end{matrix} ] \\ V = [ \begin{matrix}1 & 0 & 0 & 0 \\ 0 & 1 & 0 & 0 \\ 0 & 0 & - 1 & 0 \\ 0 & 0 & 0 & 0\end{matrix} ] \cdot R \cdot [ \begin{matrix}1 & 0 & 0 & {t}_{x} \\ 0 & 1 & 0 & {t}_{y} \\ 0 & 0 & 1 & {t}_{z} \\ 0 & 0 & 0 & 1\end{matrix} ] , \\ P = [ \begin{matrix}\frac{1}{Aspect \times size} & 0 & 0 & 0 \\ 0 & \frac{1}{size} & 0 & 0 \\ 0 & 0 & - \frac{2}{far - near} & - \frac{far + near}{far - near} \\ 0 & 0 & 0 & 1\end{matrix} ]$$

where R is the rotation matrix, V is the view matrix. P is the projection matrix. (tx, ty, tz) is a 3D vector represents the camera world position. (rx, ry, rz, rw) is a unit quaternion that represents the camera rotation. Aspect is the screen aspect ratio, size is half height of the view frustum. far is the distance of a camera's far plane. In some embodiments, far=1000 is a default value. near is the distance of a camera's near plane. In some embodiments, near=0.3 is a default value. The 3D camera can only render objects with distances between the far plane and the near plane.

The projection of rasterization can be formulated as:

$$[ \begin{matrix}x \\ y \\ z \\ 1\end{matrix} ] \cdot VP = [ \begin{matrix}u \\ v \\ d \\ 1\end{matrix} ]$$

where (x, y, z) is the world position of mesh model's vertex. (u, v) is the pixel position on the screen, and d is the depth of the corresponding pixel.

$${[ \begin{matrix}u \\ ν \\ d \\ 1\end{matrix} ]}_{left} \cdot M = {[ \begin{matrix}u \\ ν \\ d \\ 1\end{matrix} ]}_{right} , M = {( V {P}_{left} )}^{- 1} \cdot {VP}_{r i ght} ,$$

The above equation can be used to perform reprojection, which essentially calculates the other camera's screen coordinates of each pixel from the depth map of the current camera. This reprojection process comprises a single matrix transformation and can be computed in parallel on a GPU.

In at least one embodiment, the Reprojector 140 utilizes a Thread-safe Hybrid Shader Architecture. The Reprojector 140 may utilize a Compute Shader (CS) 142. The compute shader 142 comprises a specialized programs designed for parallel GPU processing. However, mobile devices may provide limited support for CS, resulting in an insufficient performance boost and often causing additional computation burden. Flickering artifacts also appear due to the conflict of multiple threads writing to the same pixel location, which can cause flicker and shake on certain areas of the images. To overcome these challenges, at least one embodiment utilizes a thread-safe hybrid shader architecture that leverages the strengths of both Compute Shaders 142 and Image Effect Shaders (IES) 144.

The IES 144 can be used to efficiently handle matrix transformation computations, which are typically uniform and do not require random access to memory. On the other hand, the Compute Shader 142 can be specifically tasked with buffer random writing, but instead of allowing threads to operate freely across the entire image, the workload is parallelized per row of pixels. By restricting each thread to operate within a specific row, the chances of multiple threads writing to the same pixel location are eliminated.

In at least one embodiment, to optimize the use of information shared between modules during computation, disclosed embodiments utilize a novel Disocclusion Tracking method. In this approach, the Compute Shader 142 may operate in a per-row parallelized manner, enabling it to calculate and store both the location and width of disocclusions caused by the reprojection process in a single pass. By efficiently capturing this disocclusion data during the same operation, it can be seamlessly utilized by the subsequent module (i.e., the Patcher 150, as detailed below) to accelerate its processing. This design minimizes additional computational overhead while significantly improving the overall efficiency of the pipeline.

As the displays of mobile VR devices evolve, their resolution will gradually increase to 4K or even 8K. In at least one embodiment, the Reprojector 140 is independent of the scene complexity but is related to the screen resolution, which may significantly increase the computation load. To proactively address this issue, disclosed embodiments utilize resolution-independent Intermediate Buffers (ImBuffer). The resolution of the ImBuffer can be set to a constant or down-sampled ½ to 1/16 of per-eye resolution before applying YORO shaders. The ImBuffer records the distance the pixel shifts along the horizontal contour. The final full-resolution image is sampled based on linear interpolating of the distance shifted. This will avoid the extra computation burden when YORO is applied to high-resolution devices.

When down-sampling the ImBuffer from floating-point UV coordinates to integer XY pixel coordinates, errors can occur if the fractional positions are not correctly handled. In at least one embodiment, this issue is addressed by applying linear interpolation at the horizontal axis to improve image quality. While this approach doubles the shader operations, making it optional serves as a strategic design choice that enables dynamic adaptation to diverse mobile hardware capabilities—high-end devices can enable it for maximum visual quality, while devices with limited processing power can disable it to maintain performance.

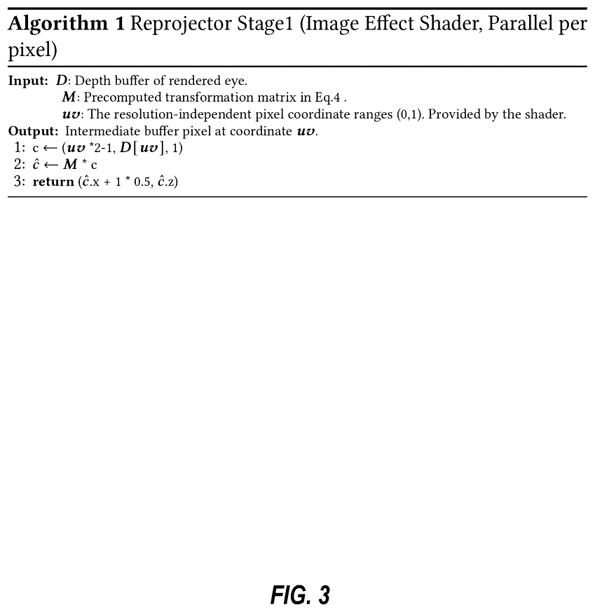

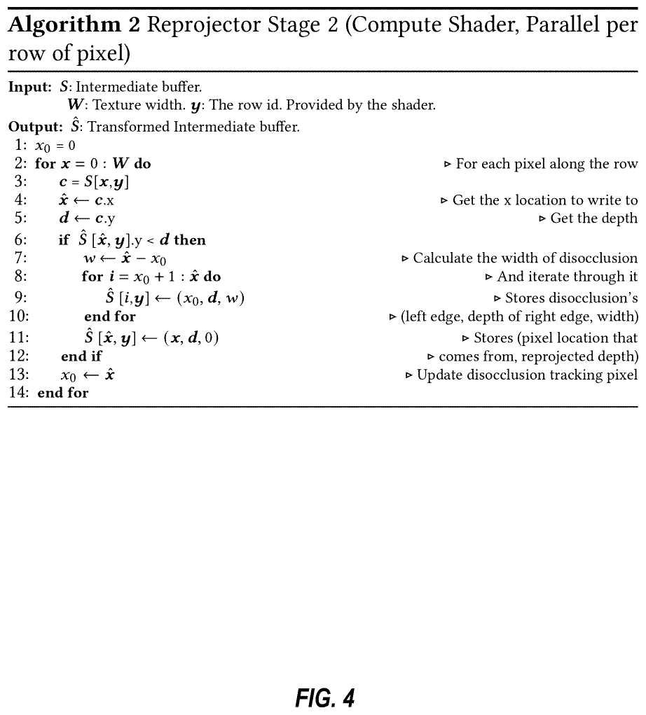

FIG. 3 illustrates an excerpt of a programming algorithm for a Reprojector First Stage, and FIG. 4 illustrates an excerpt of a programming algorithm for a Reprojector Second Stage. As shown in Algorithm 1 (shown in FIG. 3), the YORO process 210 first takes the full resolution depth map and down samples ImBuffer as input and computes the “location will be written to” value and “reprojected depth” value via a per-pixel-parallel image effect shader. However, Algorithm 1 calculates the matrix transformation but does not perform buffer random read/write operations (writing to texture location that doesn't belong to the current thread). Therefore, the ImBuffer is further fed into a per-row-parallel compute shader Algorithm 2 (shown in FIG. 4) and transforms the “location will be written to” value to “locations that come from” value via a scan along the X-axis. When multiple pixel values are written to the same location, Algorithm 2 keeps the value with the lowest depth. Besides, it will also detect if the “location will be written to” value has a change of more than one pixel (i.e., a disocclusion) and add its start location and width to the ImBuffer.

The reprojected image has a new perspective but inevitably contains some disocclusion. Therefore, disclosed embodiments utilize the Patcher 150 to fill in the disocclusion. Generally, a reprojected image will contain some disocclusions (i.e., missing some information/details). The problem of filling in the missing information of an image is called image patching or image inpainting. In at least one embodiment, a novel filter-based approach is used to patch an image. As mentioned above, disclosed embodiments store the disocclusion information in advance during the reprojector process. The disocclusion information contains the location of the nearest non-disocclusion pixel and the width of the disocclusion. This allows the Patcher 150 to quickly determine the kernel starting position and reduce the waste of texture reading operations.

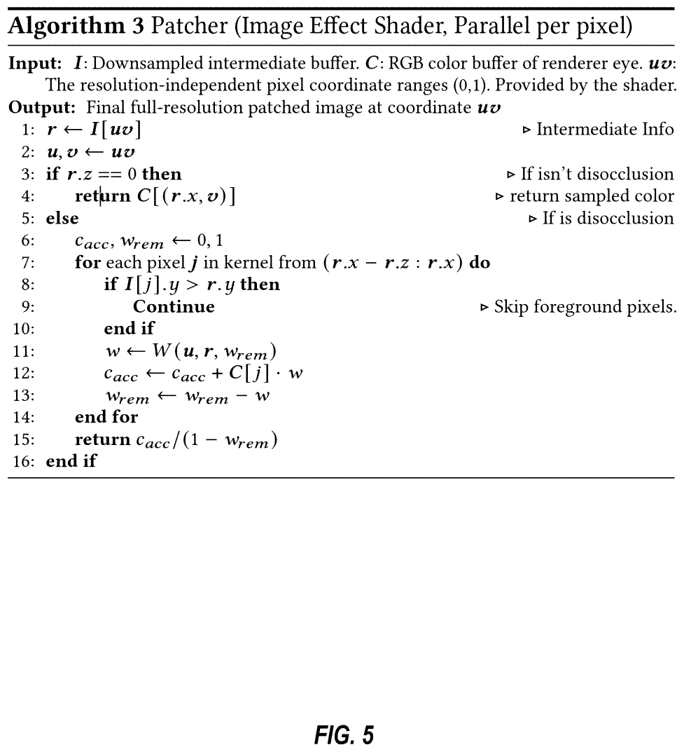

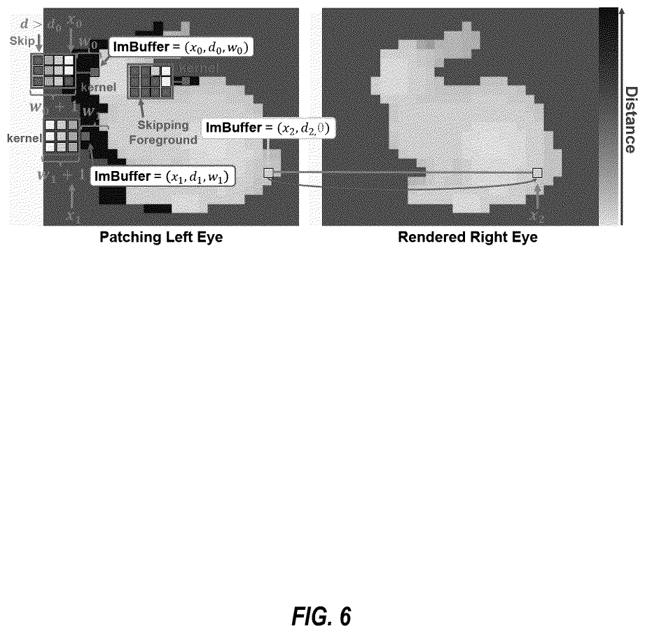

FIG. 5 illustrates an excerpt of a programming algorithm for an embodiment of a Patcher Stage. As shown in Algorithm 3 (shown in FIG. 5), the Patcher 150 is lightweight (˜20 texture memory access per pixel and parallel per pixel). For each pixel, the Patcher 150 first checks if the pixel is disocclusion (line 3). If not, the Patcher 150 returns the color sampled from the full-resolution renderer image of the rendered view, using the location provided by the ImBuffer. Since the ImBuffer is downsampled, the Patcher 150 uses UV-Coordinate samplers where linear interpolation is automatically applied. If the current pixel is disocclusion (line 5), the Patcher 150 accumulate the values of all pixels within a kernel and apply the weights. The Patcher 150 skips the foreground pixels by checking the depth of pixel candidates. The kernel may comprise the same width as the disocclusion at the current row and height of h (h=3 by default). The weights W are calculated by:

$$W ( u , r , w ) = \frac{w}{2} + 0.3 w \times ( \frac{u - {r}_{x}}{{r}_{z}} )$$

where u is the coordinate provided by the shader, r is the intermediate info, w is the remaining weight. The kernel generation is visualized in FIG. 6.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

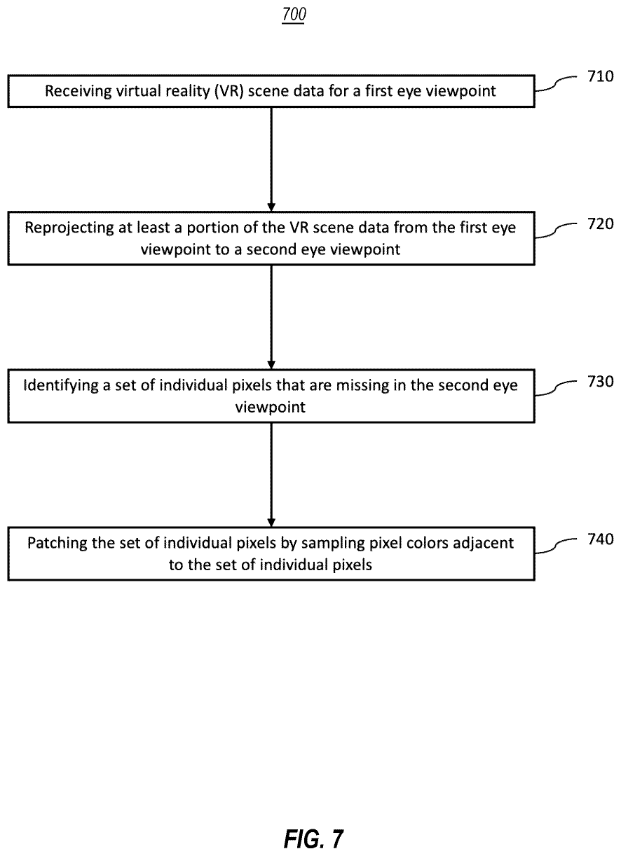

FIG. 7 is a flowchart of an example method for rendering three-dimensional video in a single rendering. The method 700 includes a step 710, of receiving virtual reality (VR) scene data for a first eye viewpoint. For example, FIG. 2 depicts VR scene data 202 for a single eye being received by a YORO process 210.

Additionally, method 700 includes a step 720 of reprojecting at least a portion of the VR scene data from the first eye viewpoint to a second eye viewpoint. For example, FIG. 3 and FIG. 4 describe example algorithms for reprojecting VR scene data from a first eye view point to a second eye view point. Method 700 may also include a step 730 of identifying a set of individual pixels that are missing in the second eye viewpoint. For example, FIG. 5 describes an example algorithm for patching missing pixels in the reprojected second eye viewpoint. In method 700, step 740 may include patching the set of individual pixels by sampling pixel colors adjacent to the set of individual pixels. For example, FIG. 6 illustrates a kernel being applied to disoccluded pixels.

Accordingly, disclosed embodiments relate to an optimized virtual reality (VR) system designed to enhance the efficiency and performance of VR rendering. Traditional VR systems require separate renderings for each eye to create a stereoscopic effect, which is computationally intensive and challenging to achieve real-time performance, especially on consumer-grade hardware. The proposed system introduces a novel approach called You Only Render Once (YORO), which generates binocular VR images from a monocular image through a single rendering process. This method can significantly reduce the computational load by saving half the computation required by conventional approaches.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for rendering three-dimensional video, comprising:
one or more processors; and
one or more computer-storage media having stored thereon executable instructions that when executed by the one or more processors configure the computer system to perform at least the following:
receive virtual reality (VR) scene data for a first eye viewpoint;
reproject at least a portion of the VR scene data from the first eye viewpoint to a second eye viewpoint;
identify a set of individual pixels that are missing in the second eye viewpoint; and
patch the set of individual pixels by sampling pixel colors adjacent to the set of individual pixels.

2. The computer system of claim 1, wherein the VR scene data comprises a color data and depth data.

3. The computer system of claim 1, wherein the executable instructions to identify the set of individual pixels that are missing in the second eye viewpoint include instructions that are executable to configure the computer system to:
track a disocclusion region during the reprojection of the VR scene data from the first eye viewpoint to the second eye viewpoint; and
store disocclusion information within intermediate buffers, wherein the disocclusion information comprises a location of a nearest non-disocclusion pixel and a width of the disocclusion.

4. The computer system of claim 3, wherein the executable instructions to patch the set of individual pixels by sampling pixel colors adjacent to the set of individual pixels include instructions that are executable to configure the computer system to:
determine, using the disocclusion information within the intermediate buffers, that a target pixel within the second eye viewpoint comprises a disocclusion;
accumulate values of pixels within a kernel; and
apply weights to the pixels.

5. The computer system of claim 4, wherein the executable instructions to accumulate values of pixels within a kernel include instructions that are executable to configure the computer system to:
determine, using depth pixel information within the VR scene data, that a pixel comprises a foreground pixel; and
exclude the foreground pixel from the accumulated values of pixels within the kernel.

6. The computer system of claim 4, wherein the executable instructions to accumulate values of pixels within a kernel include instructions that are executable to configure the computer system to:
determine, using depth pixel information within the VR scene data, that a pixel comprises a background pixel; and
accumulate values of background pixels within the kernel.

7. The computer system of claim 4, wherein kernel has the same width as the disocclusion.

8. The computer system of claim 4, wherein the executable instructions to reproject at least a portion of the VR scene data from the first eye viewpoint to the second eye viewpoint include instructions that are executable to configure the computer system to:
utilize a thread-safe hybrid shader architecture comprising Compute Shaders (CS) and Image Effect Shaders (IES) to handle matrix transformation computations and buffer random writing; and
apply linear interpolation at a horizontal axis to improve image quality during a down-sampling of intermediate buffers from floating-point UV coordinates to integer XY pixel coordinates.

9. The computer system of claim 8, wherein the executable instructions to reproject at least a portion of the VR scene data from the first eye viewpoint to the second eye viewpoint include instructions that are executable to configure the computer system to:
operate the CS in a per-row parallelized manner to calculate and store disocclusion data.

10. The computer system of claim 8, wherein the executable instructions to reproject at least a portion of the VR scene data from the first eye viewpoint to the second eye viewpoint include instructions that are executable to configure the computer system to:
use resolution-independent intermediate buffers to record a distance a pixel shifts along a horizontal contour.

11. A method for rendering three-dimensional video, comprising:
receiving virtual reality (VR) scene data for a first eye viewpoint;
reprojecting at least a portion of the VR scene data from the first eye viewpoint to a second eye viewpoint;
identifying a set of individual pixels that are missing in the second eye viewpoint; and
patching the set of individual pixels by sampling pixel colors adjacent to the set of individual pixels.

12. The method of claim 11, wherein the VR scene data comprises a color data and depth data.

13. The method of claim 11, wherein identifying the set of individual pixels that are missing in the second eye viewpoint comprises:
tracking a disocclusion during the reprojection of the VR scene data from the first eye viewpoint to the second eye viewpoint; and
storing disocclusion information within intermediate buffers, wherein the disocclusion information comprises a location of a nearest non-disocclusion pixel and a width of the disocclusion.

14. The method of claim 13, wherein patching the set of individual pixels by sampling pixel colors adjacent to the set of individual pixels further comprises:
determining, using the disocclusion information within the intermediate buffers, that a target pixel within the second eye viewpoint comprises a disocclusion;
accumulating values of pixels within a kernel; and
applying weights to the pixels.

15. The method of claim 14, wherein accumulating values of pixels within a kernel comprises:
determining, using depth pixel information within the VR scene data, that a pixel comprises a foreground pixel; and
exclude the foreground pixel from the accumulated values of pixels within the kernel.

16. The method of claim 14, wherein accumulating values of pixels within a kernel comprises:
determining, using depth pixel information within the VR scene data, that a pixel comprises a background pixel; and
accumulated values of background pixels within the kernel.

17. The method of claim 14, wherein kernel has the same width as the disocclusion.

18. The method of claim 14, wherein reprojecting at least a portion of the VR scene data from the first eye viewpoint to the second eye viewpoint further comprises:
utilizing a thread-safe hybrid shader architecture comprising Compute Shaders (CS) and Image Effect Shaders (IES) to handle matrix transformation computations and buffer random writing; and
applying linear interpolation at a horizontal axis to improve image quality during a down-sampling of intermediate buffers from floating-point UV coordinates to integer XY pixel coordinates.

19. The method of claim 18, wherein reprojecting at least a portion of the VR scene data from the first eye viewpoint to the second eye viewpoint comprises:
operating the CS in a per-row parallelized manner to calculate and store disocclusion data.

20. The method of claim 16, wherein reprojecting at least a portion of the VR scene data from the first eye viewpoint to the second eye viewpoint further comprises:
using resolution-independent intermediate buffers to record a distance a pixel shifts along a horizontal contour.
